(19) United States
(12) Patent Application Publication
(10) Pub. No.: US 2014/0222307 A1
(43) Pub. Date: Aug. 7, 2014

(54) Method for Tightening an Electromechanical Brake, and Electromechanical Brake

(71) Applicants: Wolfgang Richter, Oberursel (DE); Christoph Buelte, Kelkheim (DE)

(72) Inventors: Wolfgang Richter, Oberursel (DE); Christoph Buelte, Kelkheim (DE)

(73) Assignee: Continental Teves AG & Co. oHG, Frankfurt (DE)

(21) Appl. No.: 14/232,940

(22) PCT Filed: Jul. 16, 2012
(86) PCT No.: PCT/EP2012/063862

§ 371 Date: Mar. 13, 2014

(30) Foreign Application Priority Data
Jul. 19, 2011 (DE) 10 2011 079 362.3

(51) Int. Cl. B60T 8/17; F16D 65/38

(52) U.S. Cl. CPC B60T 8/17; F16D 65/38; F16D 2065/386
USPC 701/70

(57) ABSTRACT

A method and apparatus for retightening an electromechanical brake of a type having an actuator driven by an electric motor to provide parking brake functionality, which presses a brake element against a brake body during a force stroke. A number of successive force strokes are performed wherein the force strokes occur when the brake clamping force falls below a predefined minimum setpoint value, wherein the respective force stroke occurs such that a predefined maximum clamping force is not exceeded, and based on the initial and the expected end temperatures of the brake body, a total clamping force loss to be expected is determined. The time of a final force stroke is selected such that the sum of the forces provided by the preceding force strokes, the force of the final force stroke, and the clamping force loss still to be expected exceeds the total clamping force loss to be expected.

### CROSS REFERENCE TO RELATED APPLICATIONS

This application claims priority to German Patent Application No. 10 2011 079 362.3, filed Jul. 19, 2011 and PCT/EP2012/063862, filed Jul. 16, 2012.

### FIELD OF THE INVENTION

The invention relates to a method for retightening an electromechanical brake having an actuator which is driven by an electric motor, which actuator, to provide parking brake functionality, presses a brake element against a brake body during a force stroke, wherein for retightening, a number of temporally successive force strokes are performed. The invention also relates to a corresponding electrochemical brake.

### BACKGROUND

In the case of an electromechanical brake (EMB) or electromechanically actuatable brake, the corresponding wheel is braked purely electrically by means of an electrically operated actuator. Such brakes are normally in the form of disk brakes, wherein during a braking process, a brake piston presses a brake shoe against a brake disk by an electric motor via a spindle drive driven by the electric motor. Such brakes are normally controlled by a control and regulating unit and normally each include dedicated electronics on the brake caliper for the purpose of adjusting a wheel-specific braking force. EMBs may be used in brake-by-wire brake systems in which each of the four wheels is braked purely electrically. They may also be used in so-called combined brake systems in which, for example, the wheels on the front axle are braked hydraulically and the wheels on the rear axle are braked electrically. A further demand on an EMB is the parking brake function, which in effect simulates the handbrake in conventional vehicles.

The aforementioned parking brake function, and also the normal or service brake function, are provided on the basis of an electronic demand by further electronics and/or on the basis of routines implemented using software. Here, for the parking brake function, the legal requirement applies that a vehicle fully laden within the admissible specification must be reliably prevented from rolling away on a 20% gradient. In practice, this gives rise to the challenge of correspondingly securely holding a vehicle that has been parked while the brake disks are hot. Specifically, if a certain clamping force is set between brake pad and brake disk while the brake disks are hot, the value decreases during the course of the cooling-down process, which can result in the vehicle rolling away.

For this reason, it is necessary either to use structural measures, which commonly have disadvantages, to limit the possible force loss, or the control electronics must suitably ensure that the required clamping force continues to be ensured even when the brake disks cool down, for example by virtue of the clamping force at the brake disk being raised from a low level to a higher level again at certain time intervals by retightening. In structural terms, a reduction of the drop in force during the cooling-down process can be achieved by means of a lower rigidity of the brake caliper, but this can lead to noticeably poorer characteristics during actuation of the service brake.

Here, the clamping forces should always lie in a range which ensures that the vehicle is securely held. The control units involved in this retightening process must continue to be supplied with electrical current during this time in order to prevent an undesired force loss. The time period during which the corresponding control units are still active should be as short as possible in order to save energy and also in order to keep the risk of failure as low as possible. The time period must however be long enough that, by means of an adequate distribution of retightening processes, it can be ensured that, when the control units are deactivated and when the brake disk has fully cooled down, the vehicle is parked in the secured state. In the case of known systems, in which the clamping force is increased by the brake at fixed time intervals, the time period of the retightening must be selected to be very long in order to ensure that, after the final retightening process, the clamping force that prevails when the brake disk has cooled down is adequate for holding the vehicle.

The invention is thus based on the object of making the retightening process as effective and reliable as possible.

### SUMMARY AND INTRODUCTORY DESCRIPTION OF THE INVENTION

With regard to the method, the above-mentioned object is achieved according to the invention in that the force strokes are performed in each case when the clamping force of the brake falls below a predefined clamping force minimum setpoint value, wherein the respective force stroke is performed such that a predefined maximum clamping force is not exceeded, and wherein, on the basis of the initial temperature of the brake body and the expected end temperature of the brake body, a total clamping force loss to be expected is determined, wherein the time of a final force stroke is selected such that, at said time, the sum of the preceding force strokes, the final force stroke and the clamping force loss still to be expected exceeds the total clamping force loss to be expected.

The following additional description and drawings described advantageous refinements of the invention.

The invention is based on the consideration that, for an EMB follow-on strategy which is as effective as possible and lasts the shortest possible amount of time, knowledge and/or estimations regarding the total clamping force loss to be expected are required. Once the total clamping force loss to be expected is known, it is possible from this to calculate the sum of the force strokes required during the follow-on strategy or the retightening process.

As has now been identified, the clamping force loss at a brake disk and the temperature decrease of the brake body or of the brake disk are in an approximately linear relationship. The temperature profile itself during the cooling-down process however cannot be used as a decision value for the retightening because it is dependent on unpredictable environmental conditions such as wind and rain. That is to say, depending on environmental conditions, the brake disk may cool down more quickly or more slowly, such that predictions regarding a cooling-down time are possible only with difficulty.

It is however possible on the basis of the brake disk temperature, which is available for example from a disk temperature model, to calculate a (total) clamping force loss to be expected during the cooling-down process. That is to say, once the brake disk initial temperature when the automobile, for example, is parked and the expected brake disk end temperature are known, it is possible, with the aid of suitable parameterization, to calculate the total clamping force loss to be expected. The ultimate cooling-down time then no longer plays a role in said considerations. An end temperature assumed at the brake is typically the ambient temperature, which is available in the vehicle for example as “outside temperature”. The calculation of the clamping force loss is performed once at the start of the parking process.

This concept functions even if it is not assumed that there is a linear relationship between the brake disk temperature or temperature difference and clamping force loss, but rather the disk temperature model incorporates some other functional relationship. It is essential here that the total clamping force loss can be determined in this way. The sum of all retightening processes or of the corresponding force strokes must then compensate the entire force loss such that the initially set secure force level is attained again at the end of the cooling phase. An exponential function can be assumed as a first approximation for the cooling-down profile with respect to time, that is to say for the temperature development as a function of the time. From a mathematical aspect, this asymptotically approaches its end value but never reaches it.

If the temperature profile with respect to time were used as the basis for a follow-on strategy, this would however mean that the follow-on phase of the control units involved would also last an infinite length of time, which is of course in no way practicable. Since, as discussed above, it is not the profile with respect to time of the cooling of the brake disk but rather the total clamping force loss that is of relevance for the secure parking of the vehicle, for secure parking it must merely be ensured that the clamping force of the higher force level is adequately greater than the minimum clamping force required for preventing the vehicle from rolling away. This safety buffer can be utilized for compensating the temporally final component of the clamping force loss. In this way, the force level of the minimum clamping force is attained toward the end of the cooling-down phase, and the final retightening process is completed in a finite time.

If the profile with respect to time of the cooling-down of the brake disk were used as a basis for a follow-on strategy, it would be possible only with difficulty, owing to the above-mentioned environmental influences, to determine the times for the required retightening processes. Some other criterion is thus required which is definitive of the respective retightening process. Here, it is advantageous to know the present clamping force of the brake. Here, the clamping force of the brake disk is monitored, and retightening is performed whenever a defined minimum force value or clamping force minimum setpoint value is undershot. Here, a retightening process raises the clamping force to a higher force level.

The maximum magnitude of such force strokes and the maximum clamping force to be set in the process are dependent on the configuration of the brake and are system constants restricted by structural boundary conditions. On the one hand, the highest possible force strokes are desirable in order to keep the maximum number of force strokes for the retightening of the brake of a parked vehicle as low as possible. On the other hand, clamping forces set to excessively high values can also lead to material damage.

Since the total clamping force loss has been calculated and is now known, the time of the final force stroke is then selected such that, at said time, the sum of the preceding force strokes, of the final force stroke to be performed and of the clamping force loss still to be expected after said time exceeds the total clamping force loss to be expected. In other words: the sum of the force strokes already performed corresponds at said time to the total force loss to be expected minus the force of one force stroke. Here, a safety buffer can also be planned in, such that the final force stroke is selected such that the clamping force that is set at the end is greater, by the value of said safety buffer, than the minimum clamping force required for holding the motor vehicle.

In one preferred embodiment of the method in accordance with this invention, the time of the final force stroke is selected to be as early as possible. That is to say, when a final force stroke is sufficient to compensate the clamping force loss still to be expected such that the clamping force that is set at the end is sufficiently high, and at the same time the clamping force that is set during said force stroke is lower than the maximum clamping force, said final force stroke is performed. By virtue of the total clamping force loss having been determined, the still-remaining clamping force loss is also known at all times during the retightening process, because said still-remaining clamping force loss emerges in a simple manner from the total clamping force loss minus the magnitude of the preceding force strokes. In this way, it is thus possible to determine the earliest possible time at which a final force stroke must be performed. The selection of the earliest possible time makes it possible for the control units to be deactivated as early as possible, such that no more energy than is required for the entire retightening process need be consumed.

The time of the final force stroke is advantageously selected such that the gradient of the clamping force falls below a predefined gradient setpoint value in terms of magnitude. In effect, the gradient of the clamping force denotes the rate at which the clamping force decreases. The smaller the gradient, the smaller is the clamping force loss per unit of time.

As a result of the linking of the time of the final force stroke to the condition that the gradient in terms of magnitude, of the clamping force does not exceed a predefined gradient setpoint value, it is ensured that the change of the clamping force loss with respect to time remains below a certain value, and thus the clamping force changes, or decreases, only at a sufficiently slow rate.

In a further preferred embodiment of the method, the time of the final retightening is selected to be at the latest when a maximum time period between the first force stroke and the final force stroke is exceeded. The maximum time period may also be defined between the locking of the parking brake, or the parking of the vehicle, and the final force stroke. Through the definition of a maximum time, it is ensured that the control units do not need to be supplied with electricity for an excessively long time, which would give rise to the risk of the energy supply becoming too weak to be able to still perform a final force stroke. The maximum time does not allow an adequate clamping force to be ensured. Therefore, the maximum time must incorporate an adequate safety buffer and be checked by means of series of tests. The maximum time however ensures that the control units involved are deactivated and the vehicle battery is not completely discharged. The maximum time may be made dependent on temperature.

The determination of the present clamping force of the brake may be performed in a variety of ways. For example, said present clamping force may be determined by means of a force sensor which directly measures the force exerted on the brake disk by the brake piston or brake pad. An indirect but less robust and less reliable method for determining the present clamping force can be carried out by measuring the motor current of the electric motor that drives the actuator.

The determination of the temperature of the brake body or of the brake disk is advantageously performed by means of a temperature model, in particular on the basis of the clamping force loss of the brake body. The temperature of the brake disk or of the brake body correlates with the force loss that can be measured for example in the first minute after the locking of the parking brake. A plausibility check of the disk temperature can be performed in this way. Alternatively or in combination therewith, if redundancy is desired or demanded, the brake disk temperature may also be measured directly.

A typical disk temperature model has, during the cooling-down process, an exponential profile with which, in the case of a high temperature difference between the brake and ambient air, a correspondingly high temperature decrease is calculated. An approximation formula is as follows:

T(t)=T_{end}+T[(Tᵢₙᵢₜᵢₐₗ−T_{end})*(e^{-(k*t)}]

In the case of heating as a result of braking, the temperature increase is dependent on clamping force, friction coefficient of the brake pads, vehicle speed etc.

The above-mentioned object of the invention is achieved, with regard to the electromechanical brake, by means of a control and regulating unit with means for carrying out the above-stated method. Said means preferably includes routines implemented using hardware and/or software. Said routines may for example be implemented in an already existing control unit. Alternatively, a separate control and regulating unit may also be provided in which the corresponding routines or method steps are implemented using hardware and/or software.

The advantages of the invention lie in particular in the fact that, owing to the fact that the total clamping force loss to be expected is determined on the basis of the initial temperature and end temperature of the brake body, information regarding the actual cooling-down process of the brake body is not required, and instead the time of the final force stroke is dependent only on the sum of the previous force strokes and the clamping force loss still to be expected. If the time of the final force stroke is selected to be as early as possible, the time period over which the control units must be active is kept as short as possible.

Owing to the determination of the temperature of the brake body on the basis of a temperature model, in particular on the basis of the clamping force loss of the brake body, it is possible for temperature sensors to be dispensed with, or for redundancy to be established if such temperature sensors are provided. For the described method, it is also not necessary for the absolute temperatures to be measured and/or determined, rather only the temperature difference between the initial temperature and end temperature must be measured and/or determined.

An electromechanical brake in accordance with this invention having a control and regulating unit with means for carrying out the above-stated method makes it possible for a corresponding vehicle to be parked in an energy-saving but nevertheless reliable manner. For the implementation of the described method, it is possible for electronic components that are used for other regulating processes to be utilized jointly, for example by virtue of the method being implemented as a software routine.

### BRIEF DESCRIPTION OF THE DRAWINGS

An exemplary embodiment of the invention will be explained in more detail on the basis of a drawing, in which, in a highly schematic illustration:

FIG. 1 shows a flow diagram of a method for the retightening of an electromechanical brake in a preferred embodiment, and

FIG. 2 shows the profile with respect to time of the clamping force of said brake during an exemplary retightening process using the method illustrated in FIG. 1.

### FURTHER DESCRIPTION THE INVENTION

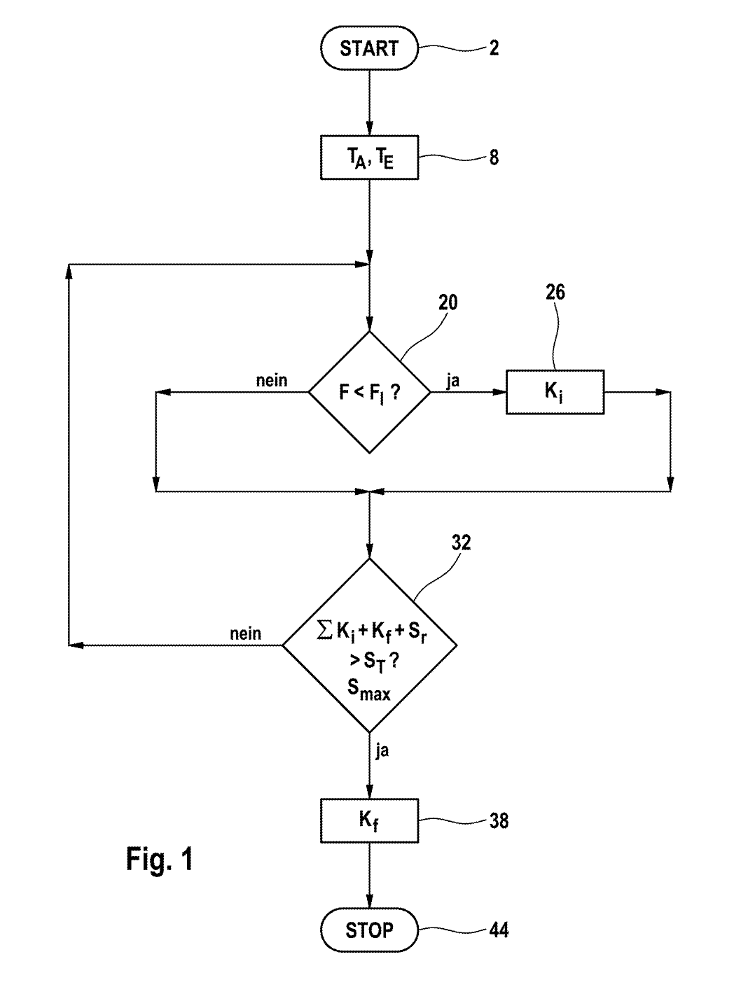

A flow diagram of the method according to the invention in a preferred embodiment is illustrated in FIG. 1. At the start 2, the vehicle is parked and the parking brake function is activated. In block 8, on the basis of the clamping force loss within the first minute after the start 2 and on the basis of the initial temperature T_{A} and the end temperature T_{E} to be expected, or the difference T_{A}-T_{E}, of the brake disk, the total clamping force loss S_{T} of the brake to be expected is determined.

The calculation of the total clamping force loss S_{T} may also be performed not only at the start of the method, as shown here, but also between the further method steps, such that the initially determined value can, in effect, be corrected if required.

In the decision block 20, it is checked whether the presently acting force or clamping force F is lower than a clamping force minimum setpoint value Fₗ (I for a limit). If this is the case, the method branches to block 26, by virtue of a force produced by a stroke stroke Kᵢ being performed, by means of which the force or the clamping force F is increased again. It is ensured here that the clamping force set by means of the force stroke Kᵢ does not exceed a maximum value Sₘₐₓ. In this way, damage to the brake is prevented. If the clamping force or force F was still higher than the clamping force minimum setpoint value Fₗ, no force stroke is performed. In the present exemplary embodiment, the maximum force magnitude of the force strokes Kᵢ is 4000 N.

In any case, the method then progresses to the decision block 32, in which the force sum of the preceding force strokes Kᵢ, of the remaining clamping force loss Sᵣ and of a possible final force stroke K_{f} is formed, wherein only those force strokes K_{f} that do not increase the set clamping force above a maximum clamping force value Sₘₐₓ are taken into consideration. If said sum is lower than the total clamping force loss S_{T} still to be expected, the method branches again to the check regarding whether the present clamping force is lower than the predefined clamping force setpoint value. If the sum formed in the decision block 32 is greater, then a last and final force stroke is sufficient to ensure that, after the brake disk has fully cooled down, the clamping force that there prevails is high enough to hold the vehicle. In this case, in block 38, a final force stroke K_{f} is performed, and the method ends at stop block 44.

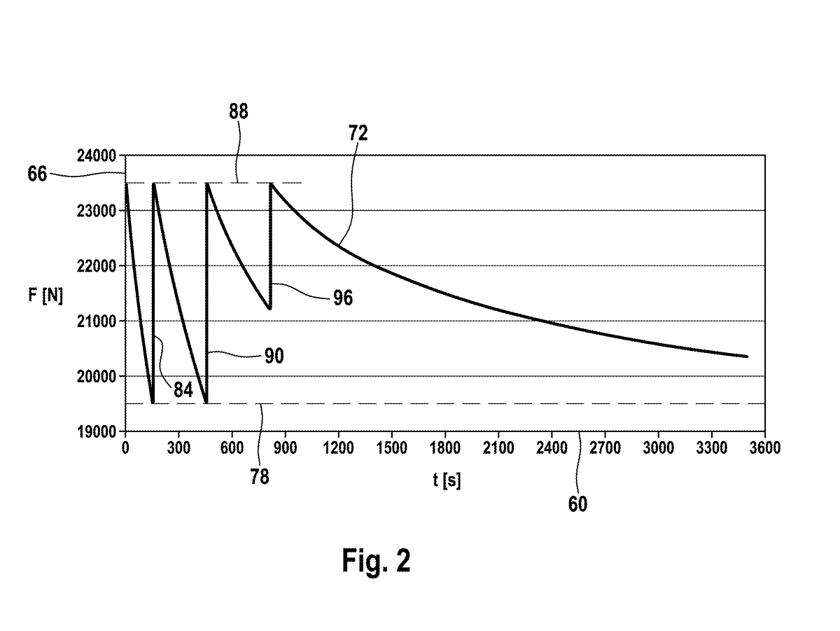

An exemplary force profile during the execution of the method described in conjunction with FIG. 1 is illustrated in FIG. 2. The time in seconds (s) is plotted on the abscissa 60, and the clamping force in newtons (N) is plotted on the ordinate 66. Here, the curve 72 represents the respectively presently prevailing clamping force value. In the present example, a clamping force minimum setpoint value (F₁) 78 that must not be undershot either during the follow-on phase or the retightening process or after the end of said process is 19.5 kN.

Starting from the time t=0 s, the brake disk cools down until, at the time t=150 s, it reaches the clamping force minimum setpoint value (F₁) 78. At said time, a first force stroke (Kᵢ) 84 of a force magnitude of 4000 N is performed. This causes the force F to be raised again to an upper force level 88 of 23,500 N, as was also present at the time t=0 s. The upper force level 88 corresponds to a predefined maximum value of the clamping force Sₘₐₓ to be set, which predefined maximum value must not be overshot in order to prevent material damage.

After the first force stroke, the brake disk cools down further, such that the clamping force falls again and reaches the clamping force minimum setpoint value (F₁) 78 again at the time t of approximately 460 s. For this reason, a second force stroke(K) 90 is now performed which causes the clamping force to be raised to the upper force level Sₘₐₓ 88 again. The brake disk then cools down further. Over the entire time, the total clamping force loss S_{T} to be expected was known, such that at all times, the magnitude of the clamping force loss Sᵣ still to be expected is also known. The last and final force stroke (K_{f}) 96 is performed precisely when (in the present example at approximately t=850 s) the present clamping force minus the remaining clamping force loss Sᵣ does not fall below a predefined level. Said level may be at the clamping force minimum setpoint value (F₁) 78, but is preferably slightly higher, such that a certain buffer is established which compensates any uncertainties or irregularities of the individual variables. The force of the final force stroke(K_{f}) 96 is only approximately 2000 N, by contrast to the forces of force strokes 84 and 90. An additional condition for the selection of the final force stroke is that the clamping force F generated by it does not exceed the upper force level 88.

While the above description constitutes the preferred embodiment of the present invention, it will be appreciated that the invention is susceptible to modification, variation, and change without departing from the proper scope and fair meaning of the accompanying claims.

1. A method for retightening an electromechanical brake having an actuator which is driven by an electric motor, which actuator, to provide a parking brake functionality, presses a brake element against a brake body during a force stroke, wherein comprising for retightening, the steps of:
performing a number of the force strokes in a temporally successive manner wherein each of the force strokes is performed when the clamping force of the brake falls below a predefined clamping force minimum setpoint value, wherein each of the force strokes is performed such that a predefined maximum clamping force is not exceeded, wherein, on the basis of the initial temperature of the brake body and the expected end temperature of the brake body, a total clamping force loss to be expected is determined, and wherein the time of a final one of the force strokes is selected such that, at the time, the sum of the forces provided by preceding force strokes of the number of force strokes, and the force of the final force stroke and the clamping force loss still to be expected exceeds the total clamping force loss to be expected.

2. The method as claimed in claim 1, wherein the time of the final force stroke is selected to be as early as possible.

3. The method as claimed in claim 1, wherein the time of the final force stroke is selected such that the gradient of the clamping force falls below a predefined gradient setpoint value.

4. The method as claimed in claim 1, wherein the time of the final force stroke is selected to be at the latest when a maximum time period between a first of the force strokes and the final force stroke is exceeded.

5. The method as claimed in claim 1, wherein the clamping force is determined by means of a force sensor.

6. The method as claimed in claim 1, wherein the clamping force is determined on the basis of the motor current of the electric motor.

7. The method as claimed in claim 1, wherein the temperature of the brake body is determined by means of a temperature model on the basis of the clamping force loss of the brake body.

8. An electromechanical brake of a type having an actuator which is driven by an electric motor, which actuator, to provide parking brake functionality, presses a brake element against a brake body during a force stroke, comprising; a control and regulating unit adapted to perform with means a method including performing a number of temporally successive force strokes wherein the force strokes are performed in each case when the clamping force of the brake falls below a predefined clamping force minimum setpoint value, wherein the respective force stroke is performed such that a predefined maximum clamping force is not exceeded, wherein, on the basis of the initial temperature of the brake body and the expected end temperature of the brake body, a total clamping force loss to be expected is determined, and wherein the time of a final force stroke is selected such that, at the time, the sum of the forces provided by the preceding force strokes, and the force of the final force stroke and the clamping force loss still to be expected exceeds the total clamping force loss.

9. The electromechanical brake of claim 8 further comprising a force sensor for measuring the clamping force.
